(19) United States
(12) Patent Application Publication
(10) Pub. No.: US 2011/0191113 A1
(43) Pub. Date: Aug. 4, 2011

(54) METHOD AND APPARATUS FOR CANONICAL NONLINEAR ANALYSIS OF AUDIO SIGNALS

(75) Inventors: Edward W. Large, Boca Raton, FL (US); Felix Amonte, Boca Raton, FL (US)

(73) Assignees: Circular Logic, LLC, Philadelphia, PA (US); Florida Atlantic University Research Corporation, Boca Raton, FL (US)

(21) Appl. No.: 13/016,713

(22) Filed: Jan. 28, 2011

Related U.S. Application Data
(60) Provisional application No. 61/299,743, filed on Jan. 29, 2010.

(51) Int. Cl. G10L 19/00

(52) U.S. Cl. 704/500; 704/E19.001

(57) ABSTRACT

The present invention is directed to systems and methods designed to ascertain the structure of acoustic signals. The approach involves an alternative transform of an acoustic input signal, utilizing a network of nonlinear oscillators in which each oscillator is tuned to a distinct frequency. Each oscillator receives input and interacts with the other oscillators in the network, yielding nonlinear resonances that are used to identify structure in an acoustic input signal. The output of the nonlinear frequency transform can be used as input to a system that will provide further analysis of the signal. According to one embodiment, the nonlinear responses are defined as a network of n expanded canonical oscillators zᵢ, with an input, for each oscillator as a function of an external stimulus. In this way, the response of oscillators to inputs that are not close to its natural frequency are accounted for.

### CROSS-REFERENCE TO RELATED APPLICATION

This application claims priority to U.S. Provisional patent Application No. 61/299,743 filed Jan. 29, 2010, in the entirety hereby incorporated by reference.

The United States Government has rights in this invention pursuant to Contract No. FA9550-07-00095 between Air Force Office of Scientific Research and Circular Logic, LLC and Contract No. FA9550-07-C-0017 between Air Force Office of Scientific Research and Circular Logic, LLC.

### BACKGROUND OF THE INVENTION

1. Statement of the Technical Field

The present application relates generally to the perception and recognition of an audio signal input and, more particularly, to a signal processing method and apparatus for providing a nonlinear frequency analysis of structured audio signals which mimics the operation of the human ear.

2. Description of the Related Art

In general, there are many well-known signal processing techniques that are utilized in signal processing applications for extracting spectral features, separating signals from background sounds, and finding periodicities at the time scale of music and speech rhythms. Generally, features are extracted and used to generate reference patterns (models) for certain identifiable sound structures. For example, these sound structures can include phonemes, musical pitches, or rhythmic meters.

Referring now to FIG. 1, a general signal processing system in accordance with the prior art is shown. The processing system will be described relative to acoustic signal processing, but it should be understood that the same concepts can be applied to processing of other types of signals. The processing system 100 receives an input signal 101. The input signal can be any type of structured signal such as music, speech or sonar returns.

Typically, an acoustic front end (not shown) includes a microphone or some other similar device to convert acoustic signals into analog electric signals having a voltage that varies over time in correspondence to the variation in air pressure caused by the input sounds. The acoustic front end also includes an analog-to-digital (ND) converter for digitizing the analog signal by sampling the voltage of the analog waveform at a desired sampling rate and converting the sampled voltage to a corresponding digital value. The sampling rate is typically selected to be twice the highest frequency component in the input signal.

In processing system 100, spectral features can be extracted in a transform module 102 by computing a wavelet transform of the acoustic signal. Alternatively, a sliding window Fourier transform may be used for providing a time-frequency analysis of the acoustic signals. Following the initial frequency analysis performed by transform module 102, one or more analytic transforms may be applied in an analytic transform module 103. For example, a “squashing” function (such as square root and sigmoid functions) may be applied to modify the amplitude of the result. Alternatively, a synchro-squeeze transform may be applied to improve the frequency resolution of the output. Transforms of this type are described in U.S. Pat. No. 6,253,175 to Basu et al. Next, a cepstrum may be applied in a cepstral analysis module 104 to recover or enhance structural features (such as pitch) that may not be present or resolvable in the input signal. Finally, a feature extraction module 105 extracts from the fully transformed signal those features that are relevant to the structure(s) to be identified. The output of this system may then be passed to a recognition system that identifies specific structures (e.g. phonemes) given the features thus extracted from the input signal. Processes for the implementation of each of the aforementioned modules are well-known in the art of signal processing.

The primarily linear foregoing audio processing techniques have proven useful in many applications. However, they have not addressed some important problems. For example, as is now known in the art, the ear and brain process sound in a nonlinear manner utilizing nonlinear oscillation. Inputs are received at the cochlea, dorsal cochlear nucleus, inferior colliculus and other brain areas where they are processed as a function of excitatory and inhibitory processes in interaction with each other to produce nonlinear neural oscillations to provide outputs to be processed by still other brain areas. The prior art suffers from the shortcoming that it utilizes a linear oscillation model to mimic the nonlinear processing of sound required to mimic the brain's processing of complex signals. As a result, these conventional approaches are not always effective for determining the structure of a time varying input signal because they do not effectively recover components that are not present or fully resolvable in the input signal. Therefore, the full range of audio responses cannot be mimicked.

To overcome these shortcomings, it is known from U.S. Pat. No. 7,376,562 (Large) to process audio signals using networks of nonlinear oscillators. This is conceptually similar to signal processing by a bank of linear oscillators, with the important difference that the processing units are nonlinear and can resonate nonlinearly. Nonlinear resonance provides a wide variety of behaviors that are not observed in linear resonance (e.g., neural oscillations). Moreover, oscillators can be connected into complex networks. FIG. 2a shows a typical architecture used to process acoustic signals. It consists of one-dimensional arrays of nonlinear oscillators, called gradient-frequency nonlinear oscillator networks (GFNNs). In FIG. 2a, GFNNs are arranged into processing layers to simulate auditory processing by the cochlea, dorsal cochlear nucleus (DCN), and inferior colliculus (ICC). From a physiological point of view, nonlinear resonance models outer hair cell nonlinearities in the cochlea, and phase-locked neural responses on the DCN and ICC (see FIG. 2b). From a signal processing point of view, processing by multiple GFNN layers is not redundant; information is added at every layer due to nonlinearities.

As seen from FIG. 2a, the oscillators are coupled together, both across a simple linear array 200 and between adjacent layers of linear arrays 200, 202, 204 of nonlinear oscillators. The connections between nonlinear oscillator pairs determines the processing of the input audio signal s(t).

A common signal processing operation is frequency decomposition of a complex input signal, for example by a Fourier transform. Often this operation is accomplished via a bank of linear bandpass filters processing an input signal, s(t). For example, a widely used model of the cochlea is a gammatone filter bank (Patterson, et al., 1992). For comparison with the Large model, it can be written as a differential equation

ż=z(α+iω)s(t) (1)

where the overdot denotes differentiation with respect to time (for example, dz/dt), z is a complex-valued state variable (function of time), ω, is radian frequency (ω=2πf, f in Hz), α, for which α<0 in the prior art model is a linear damping parameter. The term, s(t), denotes linear forcing by a time-varying external signal. For simplicity, in the above and following equations, we write z for the i^{th} filter or oscillator zᵢ. Because z is a complex number at every time, t, it can be rewritten in polar coordinates revealing system behavior in terms of amplitude, r, and phase, φ. Resonance in a linear system means that the system oscillates at the frequency of stimulation, with amplitude and phase determined by system parameters. As stimulus frequency, ω₀, approaches the oscillator frequency, ω, oscillator amplitude, r, increases, providing band-pass filtering behavior.

Recently, nonlinear models of the cochlea have been proposed to simulate the nonlinear responses of outer hair cells. It is important to note that outer hair cells are thought to be responsible for the cochlea's extreme sensitivity to soft sounds, excellent frequency selectivity and amplitude compression (e.g., Eguiluz, Ospeck, Choe, Hudspeth, & Magnasco, 2000). Models of nonlinear resonance that explain these properties have been based on the Hopf normal form for nonlinear oscillation, and are generic. Normal form (truncated) models have the form and as known from Large may be expressed as

ż=z(α+iω+β|z|²)+s(t)+h.o.t. (2)

Note the surface similarities between this form and the linear oscillator of Equation 1. Again, z is the state of an oscillator represented by the real and imaginary parts of z at a point of time within a cycle, ω is radian frequency, and α is again a linear damping parameter. However in this nonlinear formulation, α becomes a bifurcation parameter which can assume both positive and negative values, as well as α=0. The value α=0 is termed a bifurcation point. β<0 is a nonlinear damping parameter, which prevents amplitude from blowing up when α>0. Again, s(t) denotes linear forcing by an external signal. The term h.o.t. denotes higher-order terms of the nonlinear expansion that are truncated (i.e., ignored) in normal form models. Like linear oscillators, nonlinear oscillators come to resonate with the frequency of an auditory stimulus; consequently, they offer a sort of filtering behavior in that they respond maximally to stimuli near their own frequency. However, there are important differences in that nonlinear models address behaviors that linear ones do not, such as extreme sensitivity to weak signals, amplitude compression and high frequency selectivity. The compressive gammachirp filterbank exhibits nonlinear behaviors similar to Equation 2, but is formulated within a signal processing framework (Irino & Patterson, 2006).

Although the application of nonlinear oscillators and nonlinear modeling lends itself to mimic and produce outputs which represent very complex behaviors, previously unobtainable with linear models, the Large system suffers from the disadvantage that it too did not adequately process the entire frequency spectrum. The high order terms were not fully expanded. Rather, it was required that the characteristics of the wave form be known in advance, particularly the frequencies, so that only the most significant higher order terms are processed while the less significant terms are ignored even if their values do not go to 0. Therefore, a system for processing nonlinear oscillators to take advantage of and mimic substantially the entire complexity of an audio sound input is desired.

### SUMMARY OF THE INVENTION

The present invention is directed to systems and methods designed to ascertain the structure of acoustic signals. The approach involves an alternative transform of an acoustic input signal, utilizing a network of nonlinear oscillators in which each oscillator is tuned to a distinct frequency; referred to as the natural or intrinsic frequency. Each oscillator receives input and interacts with the other oscillators in the network, yielding nonlinear resonances that are used to identify structure in an acoustic input signal. The output of the nonlinear frequency transform can be used as input to a system that will provide further analysis of the signal. According to one embodiment, the nonlinear responses are defined as a network of n expanded canonical oscillators zᵢ, with an input, for each oscillator as a function of an external stimulus. In this way, the response of oscillators to inputs that are not close to its natural frequency are accounted for.

### BRIEF DESCRIPTION OF THE DRAWINGS

Other objects, features and advantages of the present invention will be apparent from the written description and the drawings in which:

FIG. 1 is a block diagram which illustrates the way in which linear frequency analysis is used in a variety of signal processing systems, in accordance with the prior art;

FIG. 2a is a diagram illustrating the basic structure of a nonlinear neural network showing an input signal;

FIG. 2b shows the graphical representation of an individual oscillator in a nonlinear oscillator network;

FIG. 3a and FIG. 3b are a graphic comparison of the approximation and the generalized resonant terms as a function of time with ε=1;

FIG. 4 is a graphical representation of the amplitude as a function of frequency for the approximation and the generalized resonant terms with ε=1; and

FIG. 5 is a block drawing of a system for processing a nonlinear signal in accordance with the invention.

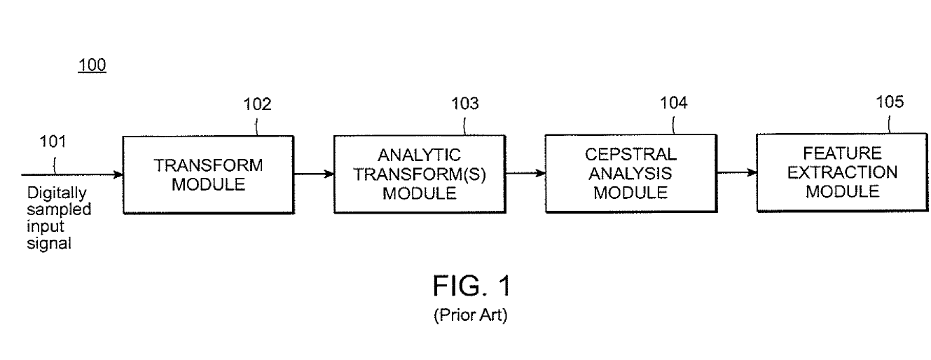

### DETAILED DESCRIPTION OF THE PREFERRED EMBODIMENTS

In the current invention a canonical model is utilized to solve for and account for all of the frequencies for the higher order terms. In this way, in order to model the response of the nonlinear neural network, it is not required to know anything about the wave form because, rather than in the nonlinear operation of Large which selects only the consequential significant high order terms, the present method solves for all of the high order terms.

This enables efficient computation of gradient frequency networks of nonlinear oscillators, representing a radical improvement to the technology. The canonical model (Equation 3, below) is related to the normal form (Equation 2; see e.g., Hoppensteadt & Izhikevich, 1997; Murdock, 2003), but it has properties beyond those of Hopf normal form models because the underlying, more realistic oscillator model is fully expanded, rather than truncated. The complete expansion of higher-order terms produces a model of the form

$${\dot{z}}_{i} = {z}_{i} ( {α}_{i} + i {ω}_{i} + ( {β}_{1 i} + i {δ}_{1 i} ) {\vert {z}_{i} \vert}^{2} + \frac{( {β}_{2 i} + i {δ}_{2 i} ) ε {\vert {z}_{i} \vert}^{4}}{1 - ε {\vert {z}_{i} \vert}^{2}} ) + RT . \qquad ( 3 )$$

Equation 3 describes a network of n nonlinear oscillators, and as will be discussed, solves for the response of each oscillator, i.e., the response at each frequency of the system. Equation 3 oscillatory dynamics follow well known cases such as Andronov-Hopf and generalized Andronov-Hopf (Bautin) bifurcations (Guckenheimer & Holmes, 1983; Guckenheimer & Kuznetsov, 2007; Wiggins, 1990; Murdock, 2003).

There are surface similarities with the models of Equations 2 and 3. The parameters, ω, α and β₁ correspond to the parameters of the truncated model of Equation 2. However, β₂ is an additional amplitude compression parameter. Two frequency detuning parameters δ₁ and δ₂ are new in this formulation, and make oscillator frequency dependent upon amplitude to better mimic real world behavior of the hair cell inputs found in the ear. The parameter ε controls the amount of nonlinearity in the system.

RT (resonant terms) represents a general expression mainly consisting of nonlinear (resonant) monomials. These nonlinearities are critical for pattern recognition and auditory scene analysis capabilities. In general, the canonical model given by Equation 3 is more general than the Hopf normal form and encompasses a wide variety of behaviors that are observed neither in the Large use of Hopf normal form, nor in linear oscillators (filters).

Higher order terms of the normal form are necessary to capture the response of an oscillator to input that is not close to its natural frequency. In Large, coupling terms were written as sums of higher order terms based on normal form theory, which is known in the art. The present invention employs the linear relationship, or resonance, given by Equation 4 in terms of the system's eigenvalues. The behavior of the system is a function of the intrinsic frequency of each oscillator in the system; this method automatically accounts for those values which go to zero, and those which remain with significant resonance. Note that near an Andronov-Hopf bifurcation, the absolute values of the eigenvalues of a canonical oscillator system are the same as their natural frequencies {ω₁, . . . , ωₙ} (Hoppensteadt & Izhikevich, 1996, 1997). In this case, the resonance relationship satisfies:

ωᵣ=m₁ω₁+ . . . +mₙωₙ

n∈ [symbol] ; m₁ . . . , mₙ∈ [symbol] ; ωᵣ, ω₁, . . . ωₙ∈ [symbol] (4)

Wherein [symbol] =set of all integers, [symbol] =set of all positive integers, and [symbol] =set of all real numbers.

The number ωᵣ is known as the resonant frequency and is typically restricted to be positive.

These considerations lead to an expanded canonical oscillator model (e.g., Equation 3) for a nonlinear neural oscillator z under the influence of input x(t). In the expanded model, the resonant terms RT include all monomials obtained (as described above) satisfying Equation 4. Including all resonant monomials in RT allows the model to respond appropriately to external stimuli, regardless of frequency, because only the monomials that are resonant with the stimulus will have a significant effect on oscillator dynamics in the long term.

We can now define a network of n expanded canonical oscillators zᵢ, with external input x(t). From now on, to avoid notational complexity and depending on the context, it is assumed that x represents a function of time t, that is, x=x(t). In most applications, either x=an input signal s(t) or x is a signal originating from other oscillators. In more general cases, x may represent a set of parameters and functions of time.

As a first case, we consider an expansion of RT for a sinusoidal external stimulus of unknown frequency, x(t)=Fe^{2πift+φ}; F,f,φ∈ [symbol] .

Wherein F is the force (amplitude) of the signal, f is the frequency of the signal, and φ is the phase.

$$\begin{matrix}RT = x + \sqrt{ε} x \overline{z} + ε x {\overline{z}}^{2} + ε \sqrt{ε} x {\overline{z}}^{3} + … + \\ \sqrt{ε} {x}^{2} + ε {x}^{2} \overline{z} + ε \sqrt{ε} {x}^{2} {\overline{z}}^{2} + {ε}^{2} {x}^{2} {\overline{z}}^{3} + … + \\ ε {x}^{3} + ε \sqrt{ε} {x}^{3} \overline{z} + {ε}^{2} {x}^{3} {\overline{z}}^{2} + {ε}^{2} \sqrt{ε} {x}^{3} {\overline{z}}^{3} + … + \\ ε \sqrt{ε} {x}^{4} + {ε}^{2} {x}^{4} \overline{z} + {ε}^{2} \sqrt{ε} {x}^{4} {\overline{z}}^{2} + {ε}^{3} {x}^{4} {\overline{z}}^{3} + … \\ = ( x + \sqrt{ε} {x}^{2} + ε {x}^{3} + ε \sqrt{ε} {x}^{4} + … ) \cdot \\ ( 1 + \sqrt{ε} \overline{z} + ε {\overline{z}}^{2} + ε \sqrt{ε} {\overline{z}}^{3} + … ) .\end{matrix} \qquad ( 5 )$$

Equation 5 contains infinite geometric series that converge (see Equation 6) when |z|<1/\sqrt{ε} and |x|<1/\sqrt{ε}. Thus, the choice of ε constrains both the magnitude of the input and the magnitude of the oscillation.

The series converge as follows,

$$RT = x {\sum }_{k = 0}^{∞} {( \sqrt{ε} x )}^{k} {\sum }_{k = 0}^{∞} {( \sqrt{ε} \overline{z} )}^{k} = \frac{x}{1 - \sqrt{ε} x} \cdot \frac{1}{1 - \sqrt{ε} \overline{z}} \\ when \vert x \vert < \sqrt{1 / ε} , \vert z \vert < \sqrt{1 / ε} \qquad ( 6 )$$

Consider the relation between Equation 3 and the result shown in Equation 6 derived in the prior Large art. Equation 6 suggests, here presented as new art, a generalization for RT defined as a product of a coupling factor c and two functions; one a passive factor [symbol] (ε, x) and the other an active factor [symbol] (ε, z). We can write Equation 6 as

$$RT = c P ( ε , x ) A ( ε , z ) where \\ P ( ε , x ) = \frac{x}{1 - \sqrt{ε} x} , A ( ε , z ) = \frac{1}{1 - \sqrt{ε} z} , and \\ c = 1 in this nonlimiting example . \qquad ( 7 )$$

In the above case, x represents a single component frequency (sinusoidal) signal. In this new art we generalize RT. In the general case, x can represent an external input (e.g., a sound) of any complexity, or x can represent a coupling matrix, A, times a vector of oscillators, z. In the latter case,

x=Σαⱼzⱼ

where αⱼ ranges over a row of the matrix A (i.e., αⱼ is a row vector) and zⱼ is the j^{th} oscillator in a column vector representing the network state. Note that in both cases, x is a complex input signal to an oscillator. Also, in both cases x(t) can be written as a sum of frequency components

$$x = {\sum }_{j} {x}_{j}$$

where xⱼ represents a frequency component of the input signal defined as

xⱼ(t)=Fⱼe^{2πif}^{ⱼ}^{t+φj};Fⱼ,fⱼ,φⱼ,t∈ [symbol] .

Here, Fⱼ represents the forcing amplitude, fⱼ the components frequency, φⱼ the phase, and t is time. Given the general definition of x and xⱼ above, [symbol] (ε, x) can be formulated as a function consisting of (resonant) monomials from a set [symbol] .

[symbol]

={ε^{(-1+Σ}^{ⱼ}^{(p}^{ⱼ}^{+q}^{ⱼ}^{))/2}x₁^{p}^{₁} . . . xₙ^{p}^{ₙ} x̅₁^{q}^{₁} . . . x̅ₙ^{q}^{ₙ}|pᵢ,qᵢ∈ [symbol] ,n∈ [symbol] ,ε∈ [symbol] }

where the coefficient ε^{(-1+Σ}^{ⱼ}^{(p}^{ⱼ}^{+q}^{ᵢ}^{))/2} specifies the contribution of each term (see, e.g., Hoppensteadt & Izhikevich, 1997).

The formulation of the passive factor [symbol] (ε, x) in Equation 7 can be generalized to include other components as follows.

The generalized form of the passive nonlinearity [symbol] (ε, x) consists of a sum of expressions formed from elements of the set [symbol] above. More specifically, [symbol] (ε, x) consists of the sum of all monomials which correspond to positive frequencies ωᵣ in the resonance relation Equation 4. It is expressed as:

[symbol]

(ε,x)=Σε^{(-1+Σ}^{ⱼ}^{(p}^{ⱼ}^{+q}^{ⱼ}^{))/2}x₁^{p}^{₁} . . . xₙ^{p}^{ₙ} x̅₁^{q}^{₁} . . . x̅ₙ^{q}^{ₙ} (8)

To clarify, a monomial from the set [symbol] is included in the sum of Equation 8 if the following four conditions are satisfied. 1) n is the number of (frequency) components of a signal or of oscillators, etc. 2) The p's and q's are positive integers or 0, at least one of the p's is not zero. 3) The total number of nonzero p's and q's is less than or equal to n. 4) The resonance relation Equation 4 is satisfied with a positive resonant frequency, i.e.,

ωᵣ=p₁ω₁+ . . . +pₙωₙ−(q₁ω₁+ . . . +qₙωₙ)>0

and by rewriting we get

ωᵣ=(p₁−q₁)ω₁+ . . . +(pₙ−qₙ)ωₙ>0

where the coefficients m₁, . . . , mₙ of Equation 4 become

m₁=(p₁−q₁), . . . , mₙ=(pₙ−qₙ)

Using this form of the passive part [symbol] (ε, x) provides a very general form of RT where RT=c [symbol] (ε, x) [symbol] (ε, z).

A more explicit way of expressing this form of the passive nonlinearity [symbol] (ε, x) follows.

Let n=Number of oscillators in a network or frequency components of a signal and let:

[symbol]

={1, 2, 3, . . . , n}

{ω₁, . . . , ωₙ}=The set of the natural frequencies of the oscillators or components.

N( [symbol] )=Power Set of [symbol] \{{ }, {1}, . . . , {n}}=Set of all subsets of [symbol] minus the empty set and singleton sets.

Recall that a partition of a set S is a set of nonempty subsets of S such that every element x in S is in exactly one of these subsets. Whereas, a k-partition of a set S is a partition of S of cardinality k. Also let:

P( [symbol] )=A partition of

[symbol]

P( [symbol] ,k)=A k-partition of [symbol] ,1≦k≦n

Now we can write the passive part as:

$$P ( ε , {x}_{1} , … , {x}_{n} ) = \frac{1}{\sqrt{ε}} ( - 1 + {\prod }_{k \neq i}^{n} \frac{1}{1 - \sqrt{ε} {x}_{k}} + {\sum }_{I} ( S 1 + S 2 ) ) \qquad ( 9 )$$

where l is an index set and

$$I = \{ {P}_{1} , {P}_{2} \} ∈ P ( S ∈ N ( {ℤ}_{n}^{+} ) , 2 )$$

$${\prod }_{k \neq i}^{n} \frac{1}{1 - \sqrt{ε} {x}_{k }} = {\prod }_{k \neq i}^{n} {\sum }_{p = 0}^{∞} {( \sqrt{ε} {x}_{k} )}^{p} \\ S 1 = {\sum }_{{{p}_{k 1} = 1}_{k 1 ∈ {P}_{1}}}^{∞} {\sum }_{{{q}_{k 2} = 1}_{k 2 ∈ {P}_{2}}}^{∞} H 1 \cdot ( {\prod }_{k 1 ∈ {P}_{1}} {( \sqrt{ε} {x}_{k 1} )}^{{p}_{k 1}} ) ( {\prod }_{k 2 ∈ {P}_{2}} {( \sqrt{ε} {\overline{x}}_{k 2} )}^{{q}_{k 2}} )$$

$$S 2 = {{\sum }_{{{p}_{k 1} = 1}_{k 1 ∈ {P}_{2}}}}^{∞} {\sum }_{{{q}_{k 2} = 1}_{k 2 ∈ {P}_{1}}}^{∞} H 2 \cdot ( {\prod }_{k 1 ∈ {P}_{2}} {( \sqrt{ε} {x}_{k 1} )}^{{p}_{k 1}} ) ( {\prod }_{k 2 ∈ {P}_{1}} {( \sqrt{ε} {\overline{x}}_{k 2} )}^{{q}_{k 2}} )$$

$$H 1 = ( 1 + \frac{h 1 + h 2}{\vert h 1 + h 2 \vert} ) / 2 , H 2 = ( 1 + \frac{h 3 + h 4}{\vert h 3 + h 4 \vert} ) / 2 \\ h 1 = {\sum }_{k 1 ∈ {P}_{1}} {p}_{k 1} {ω}_{k 1} , h 2 = - {\sum }_{k 2 ∈ {P}_{2}} {q}_{k 2} {ω}_{k 2} \\ h 3 = {\sum }_{k 1 ∈ {P}_{2}} {p}_{k 1} {ω}_{k 1} , h 4 = - {\sum }_{k 2 ∈ {P}_{1}} {q}_{k 2} {ω}_{k 2}$$

h1 and h2 are frequency correcting factors.

Equation 9 provides a method for computing coupling within and/or between gradient frequency oscillator networks. The expression

$$\frac{1}{\sqrt{ε}} ( - 1 + {\prod }_{k \neq i}^{n} \frac{1}{1 - \sqrt{ε} {x}_{k}} )$$

contained in Equation 9 represents the complete set of harmonics present in a stimulus to which oscillators, e.g., in a GFNN, can resonate. Similarly, S1 and S2 represent a complete set of combination and difference frequencies. Thus, all higher order resonances are accounted for in this formulation.

There is another form of [symbol] (ε, x) similar to the one above (Equation 9) which simplifies further and reduces to a real valued expression because S1 and S2 are complex conjugates. For this case, the frequency correcting factors H1 and H2 are not used.

Since the geometric series converge, S1 and S2 simplify further to produce:

$$𝒫 ( ε , {x}_{1} , … , {x}_{n} ) = \frac{1}{\sqrt{ε}} ( - 1 + {\prod }_{k \neq i}^{n} \frac{1}{1 - \sqrt{ε} {x}_{k}} + {\sum }_{I} ( U 1 + U 2 ) ) \qquad ( 10 )$$

where

$$I = \{ {P}_{1} , {P}_{2} \} ∈ P ( S ∈ N ( {ℤ}_{n}^{+} ) , 2 )$$

$$U 1 = ( {\prod }_{k 1 ∈ {P}_{1}} \frac{{x}_{k 1}}{1 - \sqrt{ε} {x}_{k 1}} ) ( {\prod }_{k 2 ∈ {P}_{2}} \frac{{\overline{x}}_{k 2}}{1 - \sqrt{ε} {\overline{x}}_{k 2}} )$$

$$U 2 = ( {\prod }_{k 1 ∈ {P}_{2}} \frac{{x}_{k 1}}{1 - \sqrt{ε} {x}_{k 1}} ) ( {\prod }_{k 2 ∈ {P}_{1}} \frac{{\overline{x}}_{k 2}}{1 - \sqrt{ε} {\overline{x}}_{k 2}} )$$

Equation 10 provides a method for computing coupling within and/or between gradient frequency oscillator networks when there is no frequency correction on the resonant monomials. In this case [symbol] (ε, x) consists of finite expressions and is a real valued signal.

The above are complicated expressions for the passive part of RT. They contain infinite sums as described above or large numbers of partitions to sum over for large n's. In practice these forms of RT may be difficult to use. The precise form of these expressions depends upon the frequencies present in the stimulus or frequencies of oscillators. To compute with the above expressions, one would have to obtain the frequency components of an input signal by Fourier analysis or some other technique. Moreover, because the computation is expensive in both space and time, one would have to limit the number of components and truncate the expansion of resonant monomials in Equation 9. This leads us to seek suitable approximations. One approximation is given by:

$$𝒫 ( ε , x ) \approx ( \frac{x}{1 - \sqrt{ε} x} ) ( \frac{1}{1 - \sqrt{ε} \overline{x}} ) \qquad ( 11 )$$

where x=Σxᵢ or an input signal x=s(t).

Equation 11 provides a method for computing coupling within and/or between gradient frequency oscillator networks. It has the advantage that it can be applied to 1) external input comprised of any number of unknown frequency components 2) input from other oscillators within the same GFNN, or 3) input from oscillators in another GFNN. It is also far more efficient to compute than Equations 9 and 10, and it approximates Equation 9 quite closely.

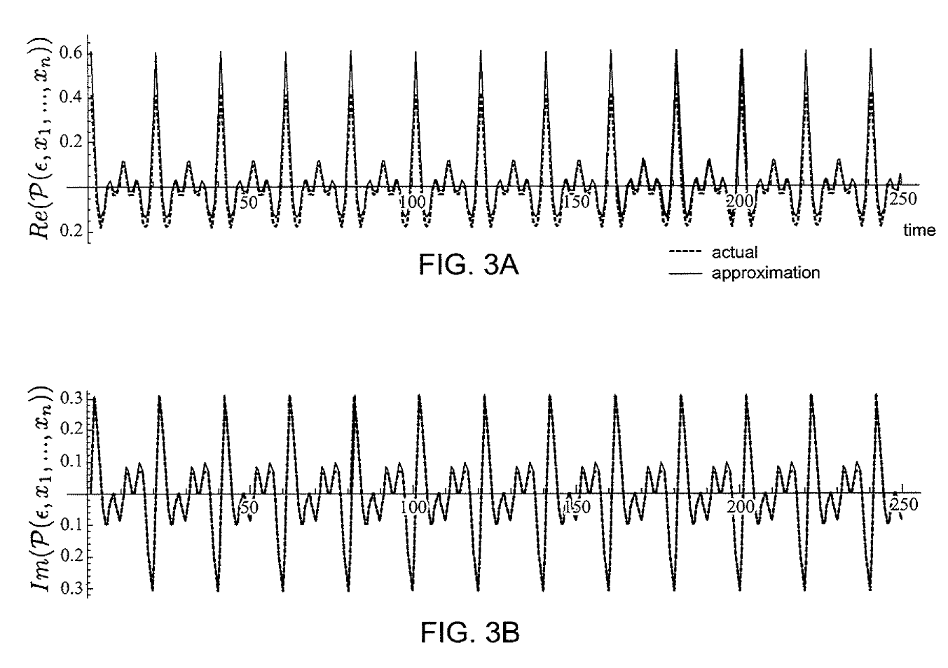

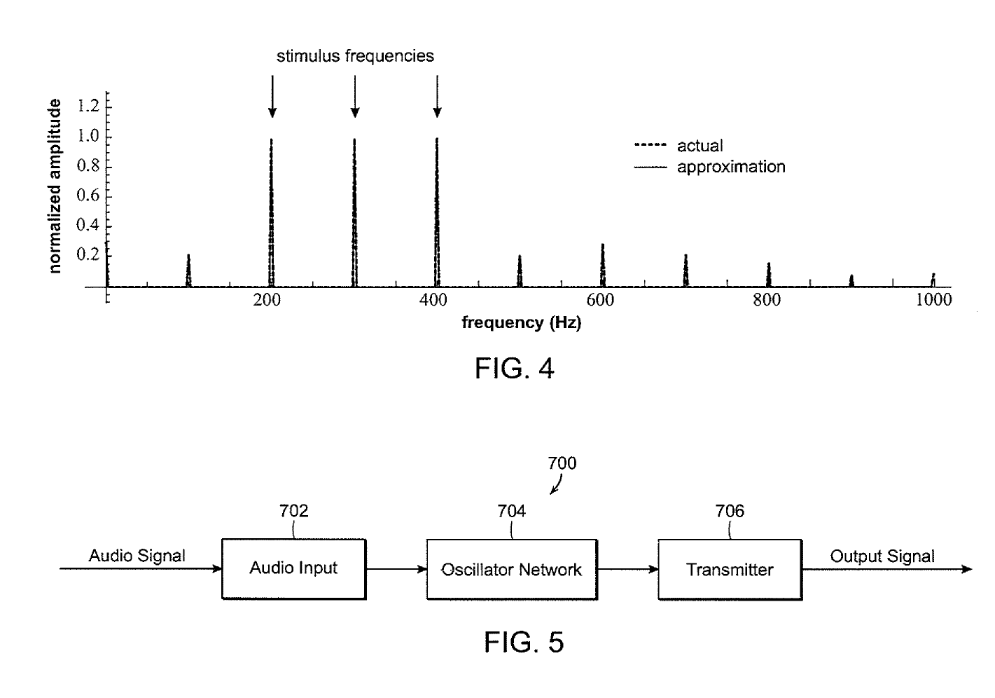

An example comparing this approximation (gray curves) and the generalized RT (black dashed curves) is shown in FIGS. 3a, 3b and 4. The generalized RT was truncated to monomials of degree 4 (per variable). There are 3 components (n=3) with respective natural frequencies f₁=200, f₂=300, f₃=400 Hz and corresponding input x₁, x₂, and x₃ with amplitude=0.1, i.e.,

x₁=0.1e^{2πi200t},x₂=0.1e^{2πi300t},x₃=0.1e^{2πi400t}

From FIG. 3, we can see that both the generalized RT and the approximation have maximum response at their natural frequencies. Harmonics and sub-harmonics are also captured. Also, the generalized RT and the approximation overlap increasingly better as the amplitude of the stimulus is decreased.

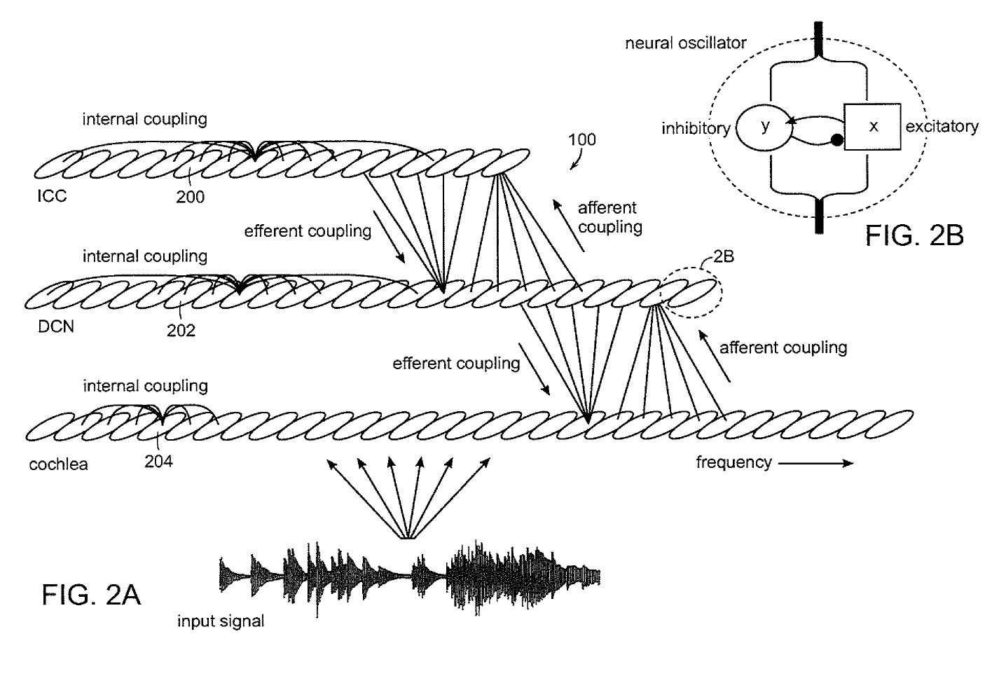

Finally, we write RT in a general abstract form covering the entire class of scenarios including separate coupling terms for inputs from different sources. This includes internal couplings, external input and input from other networks as illustrated in FIG. 2. The general formulation is as follows:

$$RT = {\sum }_{k ∈ I} {ℛ}_{k} where {ℛ}_{k} = {c}_{k} {𝒫}_{k} ( t , {x}_{k} ) {A}_{k} ( ε , z ) \qquad ( 12 )$$

[symbol]

(t, xₖ) is the k^{th} passive part, [symbol] (ε, z) is the k^{th} active part, cₖ corresponds to the strength of coupling, and l is some index set. As an example employing this generalized RT, Equation 3 can be restated to include network layers and external input signals as in FIG. 2. The equation for the complex valued state variable of the i^{th} oscillator can be written as:

$${\dot{z}}_{i} = {z}_{i} ( {α}_{i} + i {ω}_{i} + ( {β}_{1 i} + i {δ}_{1 i} ) {\vert {z}_{i} \vert}^{2} + \frac{( {β}_{2 i} + i {δ}_{2 i} ) ε {\vert {z}_{i} \vert}^{4}}{1 - ε {\vert {z}_{i} \vert}^{2}} ) + {R}_{internal} + {R}_{external} + {R}_{afferent} + {R}_{efferent} \qquad ( 13 )$$

where ω is the oscillator frequency in radians, α is a linear damping parameter, β is a nonlinear damping parameter, δ is the nature in which the oscillator frequency is dependent upon amplitude.

Each Rₖ has a unique passive nonlinearity corresponding to the internal, external, afferent, and efferent couplings respectively. The active nonlinearities are as in Equation 7.

Reference is now made to FIG. 5 wherein a system constructed in accordance with the invention for processing the signals is provided. A system 700 includes an audio input 702 such as a microphone, which provides an input to an oscillator network 704 as a time varying electrical signal. Network 704 is made up of a plurality of nonlinear oscillators for receiving the input audio signal s(t). Each oscillator of network of oscillators 704 has a different natural frequency of oscillation and obeys the dynamical equation of the form.

$${\dot{z}}_{i} = {z}_{i} ( {α}_{i} + i {ω}_{i} + ( {β}_{1 i} + i {δ}_{1 i} ) {\vert {z}_{i} \vert}^{2} + \frac{( {β}_{2 i} + i {δ}_{2 i} ) ε {\vert {z}_{i} \vert}^{4}}{1 - ε {\vert {z}_{i} \vert}^{2}} ) + RT .$$

The oscillators may be in the form of a computer which generates at least one frequency output useful for describing the time bearing structure of the input signal s(t) oscillator network 704. A transmitter 706 receives the signal and transmits it to an audio or visual display output. The computing device can be any computing device capable of analyzing a mathematical representation of a sound signal such as a computer processing unit (CPU), a field programmable gate array (FPGA) or an ASIC chip.

As can be seen from the above, it is possible to analyze complex wave signals utilizing an array of nonlinear oscillators in a manner which takes into account much more of the signal. By accounting for resonant terms and analyzing the acoustic signal in a nonlinear manner, the analysis may more closely mimic the manner in which the brain and auditory system actually operates on signals so that more of the full range of audio responses can be mimicked. It is understood that modifications can be made to the described preferred embodiments of the invention by those skilled in the art. Therefore, it is intended that all matters in the foregoing description and shown in the accompanied drawings, be interpreted as illustrative and not in a limiting sense. Thus, the scope of the invention is determined by the appended claims.

What is claimed is:

1. A method for determining at least one frequency component as present in an input signal having a time varying structure comprising the steps of:
receiving a time varying input signal s(t) to a network of n nonlinear oscillators, each nonlinear oscillator having a different natural frequency of oscillation and obeying a dynamical equation of the form of
$${\dot{z}}_{i} = {z}_{i} ( {α}_{i} + i {ω}_{i} + ( {β}_{1 i} + i {δ}_{1 i} ) {\vert {z}_{i} \vert}^{2} + \frac{( {β}_{2 i} + i {δ}_{2 i} ) ε {\vert {z}_{i} \vert}^{4}}{1 - ε {\vert {z}_{i} \vert}^{2}} ) + RT$$
wherein zᵢ is the complex valued state variable corresponding to the i^{th} oscillator, α is a linear damping parameter, ω is the oscillator frequency in radians, β₁ is a nonlinear damping parameter, β₂ is an additional amplitude compression parameter, δ₁ and δ₂ correspond to the nature in which the oscillator frequency is dependent upon amplitude, the parameter ε defines the amount of nonlinearity in the system, RT are the resonant terms; and
generating at least one frequency output from said network useful for describing said time bearing structure.

2. The method of claim 1, further comprising the step of determining RT as CₖPₖ(t, xₖ)A(ε, z) where C corresponds to the strength of coupling of the input signal.

3. The method of claim 2, wherein CₖPₖ(ε, xₖ) corresponds to the passive portion of a coupling function between at least a first nonlinear oscillator and a second nonlinear oscillator and may be represented as
$$𝒫 ( ε , x ) \approx ( \frac{x}{1 - \sqrt{ε} x} ) ( \frac{1}{1 - \sqrt{ε} \overline{x}} ) where x = {\sum }_{{a}_{j} {z}_{j}} or x = s ( t ) .$$

4. The method of claim 2, wherein CₖPₖ(ε, xₖ) corresponds to the passive portion of a coupling function between at least a first nonlinear oscillator and a second nonlinear oscillator and is represented as:
$$𝒫 ( ε , {x}_{1} , … , {x}_{n} ) = \frac{1}{\sqrt{ε}} ( - 1 + {{\prod }_{k \neq i}}^{n} \frac{1}{1 - \sqrt{ε} {x}_{k}} + {\sum }_{I} ( S 1 + S 2 ) )$$

5. The method of claim 1, wherein α is a bifurcation parameter.

6. The method of claim 2, wherein CₖPₖ(ε, xₖ) corresponds to the passive portion of a coupling function between at least a first nonlinear oscillator and a second nonlinear oscillator and may be represented as:
$$𝒫 ( ε , {x}_{1} , … , {x}_{n} ) = \frac{1}{\sqrt{ε}} ( - 1 + {{\prod }_{k \neq i}}^{n} \frac{1}{1 - \sqrt{ε} {x}_{k}} + {\sum }_{I} ( U 1 + U 2 ) )$$

7. A system for processing an audio signal comprising:
a nonlinear oscillator network, the nonlinear oscillator network including a plurality of nonlinear oscillators each oscillator having a different natural frequency of oscillation and obeying a dynamical equation of the form of
$${\dot{z}}_{i} = {z}_{i} ( {α}_{i} + i {ω}_{i} + ( {β}_{1 i} + i {δ}_{1 i} ) {\vert {z}_{i} \vert}^{2} + \frac{( {β}_{2 i} + i {δ}_{2 i} ) ε {\vert {z}_{i} \vert}^{4}}{1 - ε {\vert {z}_{i} \vert}^{2}} ) + RT$$
the nonlinear network generating at least one frequency output for describing the time bearing structure of the input signal.

8. The system of claim 7, wherein RT is determined as CₖPₖ(t, xₖ)A(ε, z), where C corresponds to the strength of coupling of the input signal.

9. The system of claim 8, wherein CₖPₖ(t, xₖ)A(ε, z) corresponds to the passive portion of a coupling function between at least a first nonlinear oscillator and a second nonlinear oscillator and may be represented as
$$𝒫 ( ε , x ) \approx ( \frac{x}{1 - \sqrt{ε} x} ) ( \frac{1}{1 - \sqrt{ε} \overline{x}} ) where x = {\sum }_{{a}_{j} {z}_{j}} or x = s ( t ) .$$

10. The system of claim 8, wherein CₖPₖ(t, xₖ)A(ε, z) corresponds to the passive portion of a coupling function between at least a first nonlinear oscillator and a second nonlinear oscillator and is represented as:
$$𝒫 ( ε , {x}_{1} , … , {x}_{n} ) = \frac{1}{\sqrt{ε}} ( - 1 + {\prod }_{k \neq i}^{n} \frac{1}{1 - \sqrt{ε} {x}_{k}} + {\sum }_{I} ( S 1 + S 2 ) )$$

11. The system of claim 7, wherein α is a bifurcation parameter.

12. The system of claim 8, wherein CₖPₖ(t, xₖ)A(ε, z) corresponds to the passive portion of a coupling function between at least a first nonlinear oscillator and a second nonlinear oscillator and may be represented as:
$$𝒫 ( ε , {x}_{1} , … , {x}_{n} ) = \frac{1}{\sqrt{ε}} ( - 1 + {\prod }_{k \neq i}^{n} \frac{1}{1 - \sqrt{ε} {x}_{k}} + {\sum }_{I} ( U 1 + U 2 ) )$$
